(19) United States
(12) Patent Application Publication
(10) Pub. No.: US 2008/0094298 A1
(43) Pub. Date: Apr. 24, 2008

(54) Antenna with Shaped Asymmetric Main Reflector and Subreflector with Asymmetric Waveguide Feed

(75) Inventors: Jay Kralovec, Viera, FL (US); Griffin Gothard, Satellite Beach, FL (US); Robert Meehan, Melbourne, FL (US); Robert Howley, Melbourne, FL (US); Kurt Zimmerman, North Melbourne, FL (US)

Correspondence Address: HARRIS CORPORATION;C/O DARBY & DARBY PC, P.O. BOX 770, CHURCH STREET STATION, NEW YORK, NY, 10008-0770, US

(73) Assignee: HARRIS CORPORATION, Melbourne, FL (US)

(21) Appl. No.: 11/551,743

(22) Filed: Oct. 23, 2006

(51) Int. Cl. H01Q 13/00

(52) U.S. Cl. 343/781 CA; 343/781 P

(57) ABSTRACT

A low-profile antenna system includes a main reflector (102) formed as a shaped main reflector surface that is approximately, but not precisely, parabolic. The main reflector (102) has a main reflector edge configuration (103) that is asymmetric. A feed system (104) for the main reflector includes a subreflector (106) formed as a shaped subreflector surface that is approximately, but not precisely, elliptical. The subreflector has a subreflector edge configuration (107) that is also asymmetric. An RF feed horn (108) associated with the feed system 104 has an aperture profile which also has an asymmetric shape.

### BACKGROUND OF THE INVENTION

1. Statement of the Technical Field

The invention concerns ring-focus reflector antenna systems, and more particularly asymmetrical reflector antennas that provide a low profile and improved performance.

2. Description of the Related Art

Satellite communication antennas are used in a wide variety of applications for providing terrestrial communications with earth orbiting satellites. The most common type of antennas used for satellite communications are dish reflector antennas. Dish reflector antennas generally are comprised of two main components, namely a reflector and a subreflector. The most common main reflectors among the high-gain reflector antennas make use of a parabolic surface, which is formed by rotating the arc of a parabola about the line joining the vertex and the focal point. When viewed along boresight (i.e., from the front), antenna reflectors typically have various shapes. For example, a paraboloid can have an edge configuration that is circular, elliptical, or any other configuration, although circular and elliptical-shapes are most common. Regardless of which shape is used, the contour of the reflector typically conforms to part of the parabolic surface.

The design of a satellite communication antenna is generally selected in order to achieve certain predetermined requirements with respect to electrical performance and physical form factor. For example, a parabolic reflector antenna with a large circularly symmetric edge configuration might provide a desired electrical performance but would be unacceptable for many applications (airborne, ship, ground) which demand low profile form factors. Phased array antennas can provide a solution to this problem in some cases. However, phased arrays tend to be very complex and expensive systems.

One way to provide a lower profile reflector antenna is to modify the edge configuration of the reflector. For example, the peripheral shape of the antenna when viewed along boresight can be modified to form an asymmetric shape. Such an asymmetrically shaped reflector can offer a lower profile as compared to conventional circular diameter reflectors. For example, an antenna reflector can be modified so that its profile changes from a 1:1 aspect ratio (e.g., a circular configuration) to a 2:3 aspect ratio elliptical configuration. While such techniques are effective for the purpose of providing a lower profile, they are also known to introduce some problems. For example, modifying a ring-focus reflector in this way is an inefficient approach if gain is to be optimized. It also produces unwanted sidelobes, which usually result from edge diffraction.

### SUMMARY OF THE INVENTION

The invention concerns a low-profile ring-focus reflector antenna system. The antenna system includes a main reflector formed as a shaped main reflector surface that is approximately, but not precisely, parabolic. The main reflector has a main reflector edge configuration that is asymmetric. A feed system for the main reflector includes a subreflector formed as a shaped sub-reflector surface that is approximately, but not precisely, elliptical. The subreflector has a subreflector edge configuration that is also asymmetric. The antenna system also includes a horn antenna extending in a direction aligned with the boresight axis. The horn antenna has an aperture that has an asymmetric shape when viewed along a boresight axis of said main reflector.

According to an aspect of the invention, the main reflector defines a shaped surface of revolution about the boresight axis of the main reflector which has no continuous surface portion thereof shaped as a regular conical surface of revolution. Alternatively, or in addition thereto, the subreflector defines a shaped surface of revolution about the boresight axis of the main reflector which has no continuous surface portion thereof shaped as a regular conical surface of revolution.

According to a second aspect of the invention, the shaped main reflector surface is defined by a plurality of curves, each respectively swept through a respective arc about a bore-sight axis of the main reflector. Each of the curves is selected so that it is approximately, but not precisely, parabolic, having no continuous surface portion thereof shaped as a regular conical surface of revolution. Alternatively, or in addition thereto, the shaped subreflector surface is defined by a plurality of curves, each respectively swept through a respective arc about a boresight axis of the main reflector. Each of the curves which define the subreflector is approximately, but not precisely, elliptical, having no continuous surface portion thereof shaped as a regular conical surface of revolution.

The main reflector and subreflector edge configurations can take several forms. For example, the edge configuration is elliptical according to one embodiment. Alternatively, one or both such edge configurations can be chosen to be approximately, but not exactly elliptical. According to another aspect of the invention, the main reflector and/or subreflector edge configuration can define a polygon.

The horn antenna associated with the feed system is installed at a first location separated by a gap from a vertex of the subreflector on the boresight axis of the antenna. In a coupled configuration, the gap is less than four wavelengths at an operational frequency at which the low-profile antenna system is designed to operate. The feed system defines a focal ring for illuminating the main reflector at an operational frequency at which the low-profile antenna system is designed to operate. Depending on the shape of the main reflector and subreflector, the focal ring can be symmetric or asymmetric.

Considered in a mere general sense, the invention is directed to a low-profile reflector antenna system which includes a main reflector formed as a shaped main reflector surface. The antenna system also includes a feed system for the main reflector. The feed system includes a subreflector formed as a shaped subreflector surface. The feed system also includes a horn antenna having an aperture and extending in a direction aligned with a boresight axis of the antenna system. At least one of the shaped main reflector surface and the shaped subreflector surface is defined by a plurality of different curves extending in a plurality of different radial directions defined in a 360 degree arc about the boresight axis. Each of the plurality of different curves is swept through a respective arc about said boresight axis to define the shaped main reflector surface and/or shaped subreflector surface.

### BRIEF DESCRIPTION OF THE DRAWINGS

Embodiments will be described with reference to the following drawing figures, in which like numerals represent like items throughout the figures, and in which:

FIG. 1 is a perspective view of a reflector type antenna with an asymmetrical main reflector, an asymmetrical subreflector, and asymmetrical waveguide matching section that is useful for understanding the invention.

FIG. 2 is a top view of the reflector type antenna system in FIG. 1.

FIG. 3 is a cross-sectional view of the reflector type antenna system in FIG. 1, taken along line 3-3.

FIG. 4 is a cross-sectional view of the asymmetric reflector type antenna system in FIG. 1, taken along line 4-4.

FIG. 5 is an enlarged perspective view of the subreflector and RF horn comprising the feed system in the reflector antenna system of FIG. 1.

FIG. 6, is a ray diagram that is useful for understanding a decoupled feed that is used with the present invention.

### DETAILED DESCRIPTION OF THE PREFERRED EMBODIMENTS

Shaped ring focus antennas typically have a main reflector and a subreflector, each formed from a conductive material or mesh. The main reflector is usually formed as a shaped surface of revolution defined by a split, approximately parabolic, curve. The subreflector is typically formed as a shaped surface of revolution defined by an approximately, but not precisely, elliptical curve. The main reflector and the subreflector each have a symmetric circular edge configuration in conventional designs. In particular, when the reflectors are viewed along a boresight axis of the antenna, the perimeter or edge of each unit forms a symmetric circular profile. Although these types of shaped ring focus antennas with circular edge configurations work well with regard to electrical performance, their form factor does not work well in all applications. For example, a conventional ring focus antenna design will have a relatively high profile when mounted on a vehicle if the antenna is to be capable of pointing from horizon to horizon.

A lower profile antenna can be achieved with antenna designs that utilize asymmetric reflectors. As used herein, the term asymmetric means any reflector shape where the distance from the boresight axis to the peripheral edge of the reflector varies as a function angular rotation around the boresight axis. For example, a reflector with an ellipsoidal peripheral edge profile would be considered asymmetric when viewed along boresight because the distance from boresight to the peripheral edge when measured along the minor axis is different as compared to the distance from boresight to the peripheral edge of the reflector when measured along the major axis of the ellipsoid. Notably, an asymmetric edge configuration, such as an ellipsoid, can result in a lower swept volume as the antenna is pointed over a 180° arc. However, ring-focus reflector antennas that utilize such asymmetric reflectors are problematic. For example, such antennas are known to be relatively inefficient with regard to antenna gain when using unshaped systems or circular symmetric shaping techniques. Such asymmetric ring-focus reflectors also increase the risk of producing unwanted sidelobes resulting from edge diffraction.

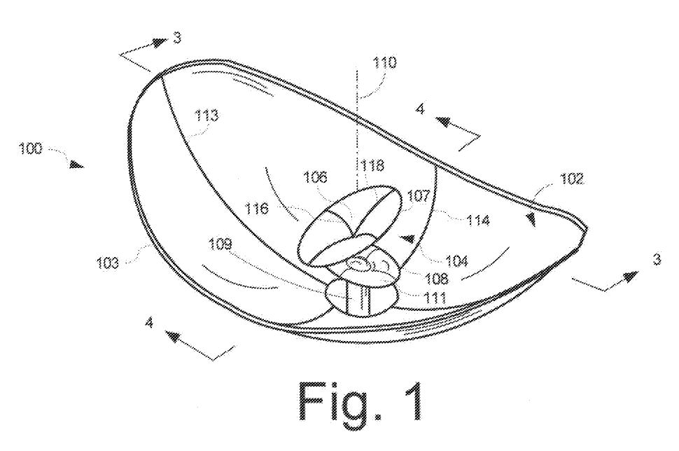

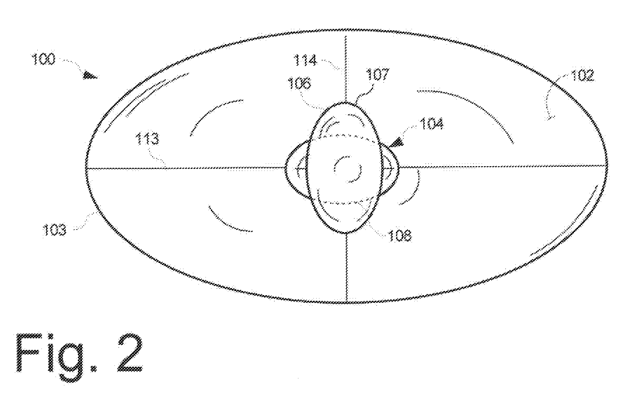

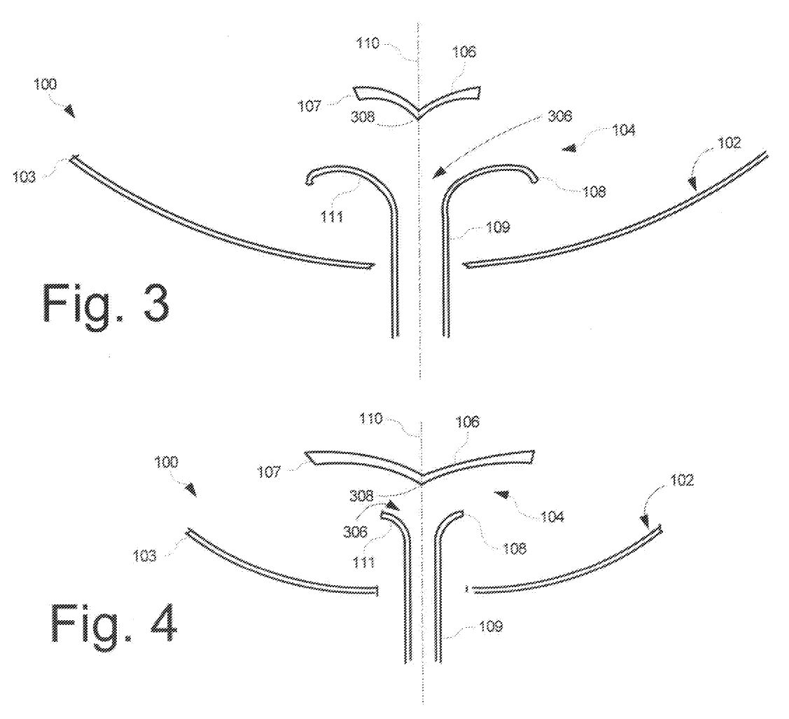

A ring-focus reflector antenna that combines the benefits of shaped antenna technology with the benefits of an asymmetric main reflector edge configuration is shown in FIGS. 1-4. Referring now to FIG. 1, there is provided a perspective view of an antenna 100 that is useful for understanding the invention. FIG. 2 is a top view of the same antenna taken along boresight. Cross-sectional views of antenna 100 are shown in FIGS. 3 and 4.

As shown in FIGS. 1-4, antenna 100 has a main reflector 102 and a subreflector 106. Each of the main reflector 102 and subreflector 106 are formed of a conductive material or mesh suitable for reflecting RF signals at a frequency of interest for which the antenna 100 is designed to operate. For purposes of clarity, the support structure for subreflector 106 is not shown. However, it will be understood by one skilled in the art that a suitable support structure is provided for positioning the subreflector as described herein.

Antenna 100 is a ring focus reflector antenna with an asymmetrically shaped main reflector 102. In particular, when the main reflector 102 is viewed along a boresight axis 110 of the antenna 100, the peripheral edge 103 of the main reflector will define an asymmetric shape. A feed system 104 for the antenna 100 is comprised of the subreflector 106 and an RF horn 108. Significantly, the subreflector 106 also has an asymmetric edge configuration. This means that when viewed along a boresight axis of the reflector, the peripheral edge 107 of subreflector 106 will have a generally asymmetric shape or profile.

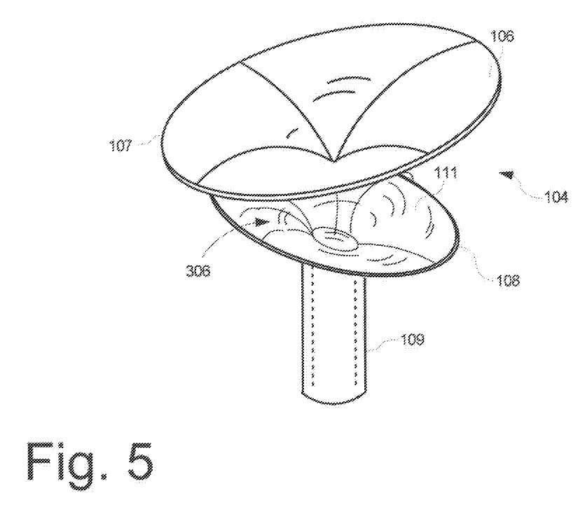

The RF horn 108 that is used in the feed system 104 includes a waveguide section defined by a throat 109. The throat 109 can have a cylindrical form. Additionally, due to the asymmetric nature of the horn, it can be advantageous to make use of a waveguide that has an asymmetrical profile when designing for applications that only require a single linear polarization. In particular, when the RF horn 108 is viewed along a boresight axis of the antenna 100, the wall that forms the interior of the throat 109 defines an asymmetric shape. The throat 109 transitions to a waveguide matching section 111 which interacts with the surface of the subreflector 106 in a manner which shall be subsequently described herein. In FIGS. 1-5, the throat 109 of RF horn 108 has a generally elliptical cross-sectional profile, which is similar to the profile of both the main reflector and subreflector. However, it should be understood that the invention is not limited in this regard. The cross-sectional profile of the RF horn 108 can be the same or different as compared to the profile of the subreflector and the main reflector as will be understood from the discussion below. In general, the asymmetric shape of the RF horn 108 will provide improved efficiency when used with the asymmetric subreflector and main reflector, as compared to the efficiency achieved with a conventional circularly symmetric RF horn in a ring-focus reflector system.

According to an embodiment of the invention, main reflector 102 is a split, approximately parabolic, surface of revolution. As used herein, this phrase means that the main reflector is formed from a surface of revolution defined by a curve that is approximately, but not precisely, parabolic. The curve is “split” in the sense that the curve has been divided along its axis and the two halves of the curve are spaced apart so as to accommodate a feed system in the center of the surface of revolution. The peripheral edge of the main reflector is modified or trimmed as necessary to define the asymmetric edge configuration. For example, in FIGS. 1-4, the edge configuration of the main reflector 102 is shown as being generally ellipsoidal. However, the invention is not limited in this regard, and any other asymmetric edge configuration could also be selected.

The subreflector 106 shown in FIGS. 1-5 is an approximately ellipsoidal surface of revolution. More particularly, the subreflector is formed as a surface of revolution defined by a curve that is approximately, but not precisely, ellipsoidal. As noted above, the peripheral edge of the subreflector is modified as necessary to define an asymmetric edge configuration. For example, in FIGS. 1-5, the peripheral edge is generally ellipsoidal. However, the invention is not limited in this regard and any other asymmetric edge configuration could also be selected. It will be noted that the major axis of the subreflector 106 is advantageously oriented in a direction that is transverse to the major axis of the main reflector 102. This configuration is selected to minimize any spillover effects that will otherwise tend to occur due to the relatively small minor axis of the main reflector. However, the invention is not limited in this regard.

Advantageously, the conical properties of the shaped subreflector 106 provide a dual focus characteristic, with one of its foci displaced toward the vicinity of the aperture of the main reflector 102 where the feed horn 108 is installed. The other focus is symmetric about the antenna boresight axis 110 in the form of a ring, which enables the antenna to obtain a substantially uniform amplitude distribution in the aperture plane. As a consequence of this geometry, the antenna is more compact than a conventional center-fed reflector antenna structure.

Notably, the sub-reflector 106 and main reflector 100 in the ring-focus antenna system of FIG. 1 are both shaped components. The term “shaped” as used herein refers to a subreflector and main reflector geometry that is defined in accordance with a prescribed set of reduced sidelobe envelope directivity pattern relationships and boundary conditions for a prescribed set of equations, rather than a shape that is definable by an equation for a regular conic, such as a parabola or an ellipse. Boundary conditions can include the dimension of the main reflector (including for example, the major and minor axis), the dimensions of the sub-reflector 106 (including for example, the major and minor axis), and the feed phase center. Given prescribed feed inputs to and boundary conditions for the antenna 100, the shape of each of the subreflector 106 and a main reflector 100 are generated by executing a computer program that solves a prescribed set of equations for the predefined constraints.

In a preferred embodiment, the equations are those which: 1—achieve conservation of energy across the antenna aperture, 2—provide equal phase across the antenna aperture, 3—obey Snell's law, and 4—provide a desired reduced sidelobe characteristic. Details of the foregoing process are discussed in U.S. Pat. No. 6,211,834 to Durham et al, the disclosure of which is incorporated herein by reference.

It will be appreciated that the shaping process as described herein can help avoid one of the primary deficiencies of using a ring focus main reflector with an asymmetric edge configuration. In particular, the shaping process can allow the antenna 100 with an asymmetric main reflector to achieve sidelobe performance characteristics that are dramatically improved as compared to conventional asymmetric ring-focus antenna designs. The inclusion of a shaped subreflector with an asymmetric edge configuration as described herein provides a further improvement in efficiency as compared to a circular symmetric edge configuration.

According to an embodiment of the invention, the computer shaping process can be modeled using boundary conditions corresponding to both the major and minor axis of an asymmetric reflector. This process can be used for the main reflector 102, the subreflector 106, or for both reflectors. Using the techniques herein described, the shaping process can determine a curve for each of the major and minor axis that satisfies a set of predefined constraints. For example, such predefined constraints can include (without limitation) a set of reduced sidelobe envelope directivity pattern relationships. According to one aspect of the invention, after a suitably shaped curve has been defined for each axis, the two curves are combined to define a single curve which represents provides a best combination of performance with respect to both the major and minor axis of the reflector(s). For example, the two curves could be averaged or their values combined using some other weighting technique. The resulting curve can then be rotated in space to define a surface of revolution for the main or subreflector.

Using the foregoing techniques, the low profile features of an asymmetric main reflector can be achieved with improved sidelobe performance as compared to conventional asymmetric main reflector based designs. Moreover, use of these shaping techniques for the main reflector and subreflector can at least partially overcome the problem of inefficiency which is normally associated with asymmetric ring-focus main reflectors. The efficiency is further improved by combining the asymmetric edge configuration of the main reflector with the asymmetric profile of the subreflector.

Once the shapes of a subreflector and main reflector pair have been generated, the performance of the antenna is subjected to computer analysis, to determine whether the generated antenna shapes will produce a desired directivity characteristic. If the design performance criteria are not initially satisfied, one or more of the parameter constraints are adjusted, and performance of the antenna is analyzed for the new set of shapes. This process is typically repeated iteratively, until the shaped pair meets the antenna's intended operational performance specification.

In the foregoing configuration, the main reflector 102 has a shaped main reflector surface defined by at least one curve swept through a defined arc (360° in this Instance) about a boresight axis 110 of the main reflector. The curve is approximately, but not precisely, parabolic. The main reflector edge configuration defines an asymmetric shape as previously described. The subreflector 106 has a shaped subreflector surface defined by at least a curve swept through a defined arc (360° in this instance) about the boresight axis. The second curve is approximately, but not precisely, elliptical, and also has a subreflector edge configuration that defines an asymmetric shape. As a result of the shaping process described herein, each of the main reflector 102 and the subreflector 106 will generally have no continuous surface portion thereof shaped as a regular conical surface of revolution.

Thus far, the main reflector 102 and the subreflector 106 have been described as surfaces of revolution. However, the invention is not limited in this regard. Due to the asymmetrical nature of both the main reflector and the subreflector, it can be advantageous in some cases to form a contoured surface of one or both of the main reflector and subreflector so that they are not true surfaces of revolution as would be produced by a single curve rotated through a defined arc of 360°. Instead, one or both of the main reflector and subreflector can conform to a different curvature in a direction aligned with its major axis as compared to its minor axis. At some intermediate point between the major and minor axis of the asymmetric reflector, one or both such curves can be modified to form a smooth transition from one curve to another. Accordingly, the curvature of the subreflector will vary as between the major and minor axis of the reflector. This technique can be used for the main reflector 102, the subreflector 106, or for both such reflectors. Consequently, the asymmetric reflectors are shaped to achieve the best combination of performance with respect to the major and minor axis of the asymmetric (in this case, elliptical) main reflector. Further, it should be understood that the focal ring of the antenna resulting from this approach may not be circularly symmetric. Instead, it can define a focal ring that is somewhat ellipsoidal, or which is otherwise distorted with respect to a circular ring.

In the foregoing configuration, the shaped main reflector surface is defined by two or more curves 113, 114 extending in a radial direction from the boresight axis 110, each swept through a respective arc about the boresight axis 110 of said main reflector 102. Each of these curves 113, 114 is approximately, but not precisely, parabolic. This means that the curves defined using the shaping method described herein will be similar to one or more truly parabolic curves, but there will be no true parabolic curve that will exactly match the set of points defined by the curves defined using the shaping method herein. Similarly, the shaped subreflector 106 is defined by a plurality of curves 116, 118, each swept through a respective arc about a boresight axis 110 of the main reflector. Each of these curves is approximately, but not precisely, elliptical. This means that the plurality of curves for the subreflector that are defined using the techniques described herein will be similar to one or mere truly elliptical curve, but there will be no true elliptical curve that will exactly match the set of points defined by the curves defined using the shaping method herein.

Those skilled in the art will appreciate that the present invention is a significant departure from systems and techniques associated with designing conventional reflector antennas. Conventional Cassegrain or Gregorian reflector antenna systems which are designed by utilizing shaping techniques generally make use of a single curve which is swept about a boresight axis to define a reflector or subreflector. This technique can also be used for conventional Cassegrain or Gregorian reflector antenna systems regardless of whether the edge configuration of such antennas is circularly symmetric or asymmetric. In the case of an antenna with a reflector and subreflector of asymmetric design, the peripheral shape of the sub-reflector can simply be trimmed to a shape that matches a desired feed pattern of the asymmetric main reflector.

Similarly, a ring-focus reflector antenna that has a circularly symmetric edge configuration can be designed using shaping techniques where a single curve swept about a boresight axis is used to define a main reflector. A single curve defined using a shaping computer code is also adequate to define a sub-reflector of a ring-focus reflector antenna that is circularly symmetric. However, this single curve approach to designing ring-focus reflector antennas is often not adequate where the edge configuration of the reflectors is not circularly symmetric. Simply trimming a peripheral edge of the sub-reflector will not produce a desired feed pattern for the asymmetric main reflector in the case of a ring-focus antenna system. This is due to the fact that the feed pattern is inverted in a ring-focus reflector antenna system. Accordingly, trimming the sub-reflector in this situation will have the undesirable effect of directing more RF power to the edges of the main reflector located along the minor axis of the asymmetric main reflector. This will cause the antenna to have poor efficiency and will increase the sidelobe levels dramatically.

In order to avoid the problems described herein with respect to ring-focus antennas having asymmetrical shaped reflectors, it is preferred to utilize a shaping process which calculates two or more unique curves 113, 114 or 116, 118 to define the shape of each reflector in a radial direction defined with respect to the boresight axis 110 of the antenna. In this regard, it will be understood that each reflector will have a shaped surface that is defined by multiple curves. The multiple curves will be respectively used to define the shape of the main or sub-reflector in a plurality of radial directions defined about the 360 degree arc around the boresight axis of the reflector. Further, it should be understood that the invention is not limited to two unique curves 113, 114 or 116, 118. For example, a different curve could be specifically calculated for use in shaping the reflector at each one degree variation in rotation around a boresight axis 110 of the reflector. This arrangement is a significant departure from conventional shaped antenna arrangements which rely on a single curve to define a surface of revolution.

It should be understood that the present invention can be utilized with a coupled or a decoupled feed configuration. In a decoupled feed/subreflector antenna, the aperture of the RF horn 108 is positioned spaced apart from a vertex 308 of the subreflector 106 by a distance at the frequency of interest which is greater than or equal to about four wavelengths. With the aperture of the RF horn in the far-field, the decoupled feed/subreflector configuration lends itself to optical design techniques such as ray tracing, geometrical theory of diffraction (GTD) and so on. Still, it is noteworthy that the relatively large distance between the aperture of the horn 108 and the vertex of the subreflector 106 can cause antenna 100 to have a relatively high profile if equipped with a decoupled feed.

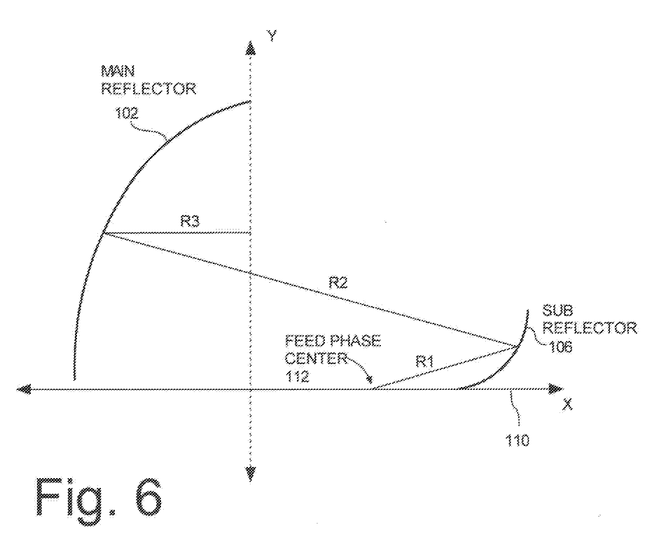

A simple ray diagram that is useful for understanding the invention as applied to a decoupled ring-focus reflector antenna system is illustrated in FIG. 6. Only half of the ray diagram is show, the other half below the x axis being the mirror image. The diagram shows the asymmetric main reflector 100 and the circularly symmetric sub-reflector 106. The size and shape of the main reflector 100 define a focal ring that is radially disposed about the x axis and spaced some distance from the main reflector 100. The boresight axis 110 of the main reflector 100 is coincident with the x axis in FIG. 6.

For the transmit path, RF energy is transmitted from a feed phase center 112 toward the sub-reflector 106 and is reflected as shown. The transmitted RF energy is shown as ray R1. The reflected RF energy from the sub-reflector 106 forms a focal ring extending radially about the x axis. The focal ring coincides with the size and location focal ring of the main reflector for illuminating the main reflector 100. The reflected RF energy from the sub-reflector 106 is identified as ray R2 in FIG. 6. When the reflected RF energy strikes the main reflector 100, it is transmitted in a direction that is generally aligned with the boresight (x axis) of the main reflector 100. This reflected ray is identified as R3 in FIG. 6

Received signals generally also traverse the path identified by rays R3, R2, and R1. Received signals strike the main reflector 100, are reflected and pass through the focal ring, are reflected by the sub-reflector 106, and finally arrive at the feed phase center 112. The phase center of the feed horn 108 is advantageously positioned so as to coincide with the phase center 112 of the sub-reflector. The exact location of the phase center relative to any feed horn 108 will be determined by a variety of factors, including the dimensions of the horn and its flare angle. Generally, the phase center will be located somewhere between the throat of the RF horn 108 and its aperture.

As noted above, a decoupled feed can cause antenna 100 to have a relatively high profile due to the relatively large distance between the aperture 306 of horn 108 and the vertex 308 of the subreflector 108. Accordingly, it can be advantageous to arrange antenna 100 to instead include a coupled-feed arrangement. When configured in this way, the RF horn 108 and the subreflector 106 are spaced more closely as compared to the decoupled configuration previously described. For example, in a coupled configuration the aperture 306 associated with the RF horn 108 and the vertex 308 of the subreflector 106 will generally be spaced apart by a distance that is less than about 2 wavelengths at the frequency of interest. When arranged in this way, the RF horn 108 and the subreflector 106 are said to be coupled in the near-field to generate what is sometimes known as a “back-fire” feed.

In a coupled-feed configuration, the RF horn 108 and the subreflector 106 in combination can be considered as forming a single integrated feed network. This single feed network is particularly noteworthy as it provides an elliptical or asymmetric waveguide to radial waveguide transition that generates a prime-ring-focus type feed for the main reflector 102. In this regard, the coupled-feed can be thought of as being similar to a prime-focus parabolic feed. Further, the subreflector 106 in this feed configuration is not truly operating as a reflector in the conventional sense but rather as a splash-plate directly interacting with the horn aperture 306.

A significant advantage of the coupled feed configuration described herein is that it can complement the low profile advantages of an asymmetric main reflector with a more compact arrangement for feed system 104. Reducing the distance between the vertex 308 of the subreflector 106 and the RF horn 108 further reduces the swept volume of the asymmetric reflector antenna system 100. The traditional disadvantages of the asymmetric main reflector are substantially avoided by using the asymmetric subreflector and the shaping techniques described herein. Moreover, the use of an asymmetric waveguide matching section improves efficiency and helps to further reduce antenna pattern sidelobes.

It is also important to note that the decoupled feed configuration has an extra degree of freedom with regards to shaping. Typically, the splash-plate of the coupled feed configuration will be generated by the shaping programs, since in many cases the coupled feed behaves as a quasi-optical system. However, since the coupled feed configuration can be designed as a single-feed-network, it is possible to design a coupled feed without shaping programs, and then shape a main reflector to the resulting coupled feed. The coupled feed is designed to have certain desirable characteristics; in this case an asymmetric feed pattern with a narrow and broad side for optimum illumination of an asymmetric main reflector. This asymmetric feed pattern is achieved by using an asymmetric splash-plate to force the pattern to the desired shape.

Once the coupled feed is designed, it will have a focal ring that is asymmetric. This asymmetric focal ring cannot be achieved using a conventional main reflector defined by a single curve swept about a boresight axis of a reflector. Accordingly, a main reflector which has a shape defined by a single curve swept about a boresight axis of the reflector will not match the focal characteristics of the coupled feed. Consequently, the main reflector must be shaped by calculating or defining suitable curves along multiple radials as described above. The number of different curves necessary can vary depending on the particular focal characteristics of the coupled feed. Accordingly, it should be understood that the shaping process will generate curves for as many radial directions as necessary in order to accurately match the focal ring of the main reflector to the phase ring of the coupled feed. Some defined curves can be used for more than one radial direction.

Once the curves for the various radial directions are determined, the main reflector is formed. In particular, the main reflector is formed by combing the curves defined for each radial direction around boresight to form the three-dimensional main reflector. It should be appreciated that this process is not trivial. For example, those skilled in the art will understand that all rays representing RF paths along all radials must still have equal path lengths to the aperture. Such equal path lengths are known in the art as necessary for maximum efficiency. Thus, an iterative process is used to refine the radials until one or more predefined specifications is/are achieved. Computer modeling and analysis can be used to determine whether the overall result meets desired system requirements.

In FIGS. 1-4, the asymmetrical main reflector 102 is illustrated as having a generally elliptical or ellipsoidal shape. However, it should be understood that the invention is not limited in this regard. The asymmetrical main reflector 100 can be formed so as to define any peripheral edge configuration that is desirable for a particular low profile application. According to one embodiment of the invention, the edge configuration is generally ellipsoidal in shape as shown. According to another embodiment of the invention, the main reflector has an edge configuration which is approximately, but not exactly ellipsoidal. Still other asymmetric shapes are also possible. For example, the main reflector can have an edge configuration which comprises a regular or non-regular polygon. Regardless of the particular shape selected, the contour of the main reflector and the subreflector can be determined using the shaping process as described herein to provide sidelobe performance characteristics and gain that is improved over conventional asymmetric antenna reflector designs. Moreover, the asymmetric subreflector can be shaped to achieve an optimal performance for the minor and major axis of the asymmetric main reflector.

When designing for applications that require only a single linear polarization, for ease of manufacturability and to aide in minimizing feed mismatch loss, it can be desirable to used elliptical waveguide to match to the elliptical horn. This allows the guide to match the throat of the feed horn, where the guide is sized to ensure only the desired waveguide modes can propagate. The guide size and shape is determined using numerical analysis techniques such as are utilized by codes like HFSS from Ansoft Corporation of Pittsburgh, Pa., or IE3D from Zeland Software, Inc. of Freemont, Calif.

It should be noted that while the antennas described herein have, for convenience, been largely described relative to a transmitting mode of operation, the invention is not intended to be so limited. Those skilled in the art will readily appreciate that the antenna can be used for receiving as well as transmitting. Further, the invention described and claimed herein is not to be limited in scope by the preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

Finally, a number of references are cited herein, the entire disclosures of which are incorporated herein, in their entirety, by reference for all purposes. Further, none of these references, regardless of how characterized above, is admitted as prior to the invention of the subject matter claimed herein.

We claim:

1. A low-profile ring-focus reflector antenna system comprising:
a main reflector formed as a shaped main reflector surface, and having a main reflector edge configuration that is asymmetric;
a feed system for said main reflector comprising a subreflector formed as a shaped subreflector surface, and having a subreflector edge configuration that is asymmetric;
a horn antenna extending in a direction aligned with a boresight axis, said horn antenna having an aperture that has an asymmetric shape when viewed along a boresight axis of said main reflector;
wherein at least one of said shaped main reflector surface and said shaped subreflector surface is defined by a plurality of different curves extending in a plurality of different radial directions in a 360 degree arc about said boresight axis.

2. The low-profile ring-focus reflector antenna system according to claim 1, wherein horn antenna has an asymmetric waveguide feed.

3. The low-profile ring-focus reflector antenna system according to claim 1, wherein said shaped main reflector surface is defined by a plurality of different curves extending in a plurality of different radial directions about said 360 degree arc.

4. The low-profile ring-focus reflector antenna system according to claim 1, wherein said shaped main reflector surface is defined by said plurality of different curves, each respectively swept through a respective arc about said boresight axis.

5. The low-profile ring-focus reflector antenna system according to claim 4, wherein at least one of said plurality of different curves defining said shaped main reflector surface is exclusive of a parabolic curve.

6. The low-profile ring-focus reflector antenna system according to claim 1, wherein said shaped subreflector surface is defined by said plurality of different curves, each respectively swept through a respective arc about said boresight axis.

7. The low-profile ring-focus reflector antenna system according to claim 6, wherein at least one of said plurality of different curves defining said shaped subreflector surface is exclusive of an elliptical curve.

8. The low-profile ring-focus reflector antenna system according to claim 1, wherein said main reflector edge configuration is elliptical.

9. The low-profile ring-focus reflector antenna system according to claim 1, wherein said subreflector edge configuration is elliptical.

10. The low-profile ring-focus reflector antenna system according to claim 1, wherein said main reflector edge configuration is approximately elliptical.

11. The low-profile ring-focus reflector antenna system according to claim 1, wherein said subreflector edge configuration is approximately elliptical.

12. The low-profile ring-focus reflector antenna system according to claim 1, wherein said main reflector edge configuration defines a polygon.

13. The low-profile ring-focus reflector antenna system according to claim 1, wherein said subreflector edge configuration defines a polygon.

14. The low-profile ring-focus reflector antenna system according to claim 1, wherein said horn antenna is installed at a first location separated by a gap from a vertex of said subreflector on said boresight axis of said antenna.

15. The low-profile ring-focus reflector antenna system according to claim 14, wherein said gap is less than four wavelengths at an operational frequency at which said low-profile ring-focus antenna system is designed to operate.

16. The low-profile ring-focus reflector antenna system according to claim 14, wherein said feed system defines a focal ring for illuminating said main reflector at an operational frequency at which said low-profile antenna system is designed to operate, and said focal ring is asymmetric.

17. The low-profile ring-focus reflector antenna system according to claim 14, wherein said horn antenna is coupled to said shaped subreflector surface.

18. A low-profile ring-focus reflector antenna system comprising:
a main reflector formed as a shaped main reflector surface, and having a main reflector edge configuration that is asymmetric;
a feed system for said main reflector comprising a subreflector formed as a shaped subreflector surface, and having a subreflector edge configuration that is asymmetric;
a horn antenna extending in a direction aligned with a boresight axis, said horn antenna having an aperture that has an asymmetric shape when viewed along a boresight axis of said main reflector;
wherein said shaped main reflector surface is defined by a plurality of different curves extending in a plurality of different radial directions in a 360 degree arc about said boresight axis, each of said plurality of different curves swept through a respective arc about said boresight axis.

19. The low-profile ring-focus reflector antenna system according to claim 18, wherein said horn antenna has an asymmetric waveguide feed.

20. The low-profile ring-focus reflector antenna system according to claim 18, wherein at least one of said plurality of different curves defining said shaped main reflector surface is exclusive of a parabolic curve.

21. The low-profile ring-focus reflector antenna system according to claim 18, wherein said shaped subreflector surface is defined by a second plurality of different curves extending in a plurality of different radial directions in said 360 degree arc, each of said second plurality of different curves respectively swept through a respective arc about said boresight axis.

22. The low-profile ring-focus reflector antenna system according to claim 21, wherein at least one of said second plurality of different curves defining said shaped subreflector surface is exclusive of an elliptical curve.

23. A low-profile reflector antenna system comprising:
a main reflector formed as a shaped main reflector surface;
a feed system for said main reflector comprising a subreflector formed as a shaped subreflector surface;
a horn antenna extending in a direction aligned with a boresight axis, said horn antenna having an aperture that has an asymmetric shape when viewed along a boresight axis of said main reflector;
wherein at least one of said shaped main reflector surface and said shaped subreflector surface is defined by a plurality of different curves extending in a plurality of different radial directions in a 360 degree arc about said boresight axis, each of said plurality of different curves swept through a respective arc about said boresight axis.
